(19) United States
(12) Patent Application Publication
(10) Pub. No.: US 2024/0348192 A1
(43) Pub. Date: Oct. 17, 2024

(54) CANAL FLOATING SOLAR AND INSTALLATION PROCESSES FOR SAME

(71) Applicant: Emrgy Inc., Atlanta, GA (US)

(72) Inventors: Thomas R. Cuthbert, III, Atlanta, GA (US); Emily Morris, Atlanta, GA (US); Sean Kenney, Atlanta, GA (US); Will Clarizio, Atlanta, GA (US); Annam Khan, Atlanta, GA (US); Michael Savoie, Atlanta, GA (US); Brandon Davis, Atlanta, GA (US)

(21) Appl. No.: 18/635,760

(22) Filed: Apr. 15, 2024

Related U.S. Application Data
(60) Provisional application No. 63/496,163, filed on Apr. 14, 2023.

(51) Int. Cl. H02S 20/00; B63B 35/44; F03B 13/26

(52) U.S. Cl. CPC H02S 20/00; B63B 35/44; F03B 13/264; B63B 2035/4453; F05B 2210/11; F05B 2220/706; F05B 2240/93

(57) ABSTRACT

A waterway power generation system and process are provided. The system may include a first turbine and a second turbine, wherein the first turbine is positioned upstream of the second turbine in a waterway; and a floating frame positioned in between the first turbine and the second turbine, wherein the floating frame comprising a string of solar panels.

### CROSS REFERENCE TO RELATED APPLICATIONS

This application claims the benefit of and priority to U.S. Provisional Patent Application No. 63/496,163 filed Apr. 14, 2023 (entitled “Canal Floating Solar and Installation Processes For Same”), which is incorporated herein by reference in its entirety.

### BACKGROUND

Existing floating solar panels or floating photovoltaic (“PV”) panels are designed for applications involving non-moving water, such as oceans, lakes, or reservoirs. Such floating solar panels may have performance issues related to high-flow rates, or other issues related to structure and/or flotation. For example, in areas of high flow rates, floating solar panels may have a tendency to become at least partially submerged. In other examples, in moving bodies of water, it is common for debris to travel within the current which can damage the solar panels if the debris makes contact with them.

As a result, there is a need for improved floating solar panel systems and methods for producing and installing the same.

### BRIEF SUMMARY OF THE DISCLOSURE

Briefly described, aspects of the present disclosure generally relate to floating solar panels for high-flow rate applications, as well as processes for making, using, and installing the same. According to a first aspect, the present disclosure relates to a power generation system comprising: a first turbine positioned in a waterway; and a floating frame positioned downstream from the first turbine; and at least one solar panel attached to the floating frame.

According to a second aspect, the power generation system of the first aspect, or any other aspect, further comprising a first mooring coupling the floating frame to the first turbine.

According to a third aspect, the power generation system of the second aspect, or any other aspect, further comprising a second turbine positioned downstream from the floating frame; and a second mooring coupling the floating frame to the second turbine.

According to a fourth aspect, the power generation system of the first aspect, or any other aspect, further comprising a first mooring coupling the floating frame to a first portion of the waterway.

According to a fifth aspect, the power generation system of the second aspect, or any other aspect, further comprising a second turbine positioned downstream from the floating frame; and a second mooring coupling the floating frame to a second portion of the waterway.

According to a sixth aspect, the power generation system of the first aspect, or any other aspect, wherein the at least one solar panel comprises a string of solar panels.

According to a seventh aspect, the power generation system of the sixth aspect, or any other aspect, wherein the string of solar panels further comprises a plurality of rows of solar panels.

According to an eighth aspect, the power generation system of the first aspect, or any other aspect, wherein the at least one solar panel is a photovoltaic panel.

According to a ninth aspect, the power generation system of the first aspect, or any other aspect, further comprising a switch, wherein the switch is configured to output both a power generated by the first turbine and a power generated by the at least one solar panel.

According to a tenth aspect, the power generation system of the first aspect, or any other aspect, further comprising a rectifier connected to the first turbine; and an inverter connected to the rectifier, wherein the inverter is further connected to the at least one solar panel.

According to an eleventh aspect, the power generation system of the tenth aspect, or any other aspect, wherein the at least one solar panel is connected to the inverter through a DC string optimizer.

According to a twelfth aspect, the power generation system of the tenth aspect, or any other aspect, further comprising: a battery bank connected to a converter; and a switch connected to both the inverter and the converter, wherein the switch is configured to output both a power generated by the first turbine and a power generated by the at least one solar panel.

According to a thirteenth aspect, the power generation system of the twelfth aspect, or any other aspect, further comprising: a control system connected to the inverter, the switch, and the converter.

According to a fourteenth aspect, the power generation system of the first aspect, or any other aspect, further comprising a bow positioned upstream of the floating frame.

According to a fifteenth aspect, the power generation system of the first aspect, or any other aspect, further comprising at least one buoy positioned upstream of the floating frame.

According to a sixteenth aspect, the present disclosure relates to a method of generating electric power comprising: generating, via a first power source, a first AC power; generating, via a second power source, a first DC power; rectifying, via a rectifier, the first AC power into a second DC power; combining, via a bus, the first DC power and the second DC power into a third DC power; inverting, via an inverter, the third DC power into a second AC power; and outputting the second AC power.

According to a seventeenth aspect, the method of the sixteenth aspect, or any other aspect, wherein the first power source is a hydrokinetic turbine generator.

According to an eighteenth aspect, the method of the sixteenth aspect, or any other aspect, wherein the second power source is one or more photovoltaic panels.

According to a nineteenth aspect, the method of the sixteenth aspect, or any other aspect, further comprising: converting, via a converter, the second AC power into a fourth DC power; and storing, via a battery bank, the fourth DC power.

According to a twentieth aspect, the method of the sixteenth aspect, or any other aspect, further comprising: providing the first power source and the second power source in a body of moving water.

According to a twenty-first aspect, the present disclosure relates to a method for installing a power generating system comprising: inserting a support frame into a body of moving water; inserting one or more portions of a hydrokinetic turbine into the body of moving water within the support frame; removing the support frame from the body of moving water; and removably anchoring a floating frame comprising at least one photovoltaic panel within the body of moving water.

According to a twenty-second aspect, the method of the twenty-first aspect, or any other aspect, wherein the step of removably anchoring a floating frame within the body of moving water further comprises: providing a mooring system; and connecting one or more portions of the floating frame with one or more portions of the hydrokinetic turbine.

According to a twenty-third aspect, the method of the twenty-first aspect, or any other aspect, wherein the step of removably anchoring a floating frame within the body of moving water further comprises: providing a mooring system; and connecting one or more portions of the floating frame with one or more areas adjacent to the body of moving water.

According to a twenty-fourth aspect, the present disclosure relates to a power generation system for use within a waterway, the power generation system comprising: a floating frame positioned within the waterway; a power module positioned on a top surface of the floating frame; a submergence management system positioned upstream of the floating frame; and a mooring system configured to removably anchor the floating frame within the waterway.

According to a twenty-fifth aspect, the method of the twenty-fourth aspect, or any other aspect, further comprising a hydrokinetic turbine positioned upstream of the floating frame.

According to a twenty-sixth aspect, the method of the twenty-fourth aspect, or any other aspect, wherein the power module includes at least one solar panel.

According to a twenty-seventh aspect, the method of the twenty-sixth aspect, or any other aspect, wherein the at least one solar panel comprises a string of solar panels.

According to a twenty-eighth aspect, the method of the twenty-fourth aspect, or any other aspect, wherein the submergence management system includes a bow.

According to a twenty-nineth aspect, the method of the twenty-fourth aspect, or any other aspect, wherein the submergence management system includes a buoy.

According to a thirtieth aspect, the method of the twenty-fourth aspect, or any other aspect, further comprising a debris management system positioned upstream of the floating frame, wherein the debris management system includes a floating barrier and a debris removal ramp.

It will be understood by those skilled in the art that one or more aspects of this disclosure can meet certain objectives, while one or more other aspects can lead to certain other objectives. Various modifications to the illustrated embodiments will be readily apparent to those skilled in the art, and the generic principles herein can be applied to other embodiments and applications without departing from embodiments of the disclosure. Other objects, features, benefits, and advantages of the present disclosure will be apparent in this summary and descriptions of the disclosed embodiments, and will be readily apparent to those skilled in the art. Such objects, features, benefits, and advantages will be apparent from the above as taken in conjunction with the accompanying figures and all reasonable inferences to be drawn therefrom.

### BRIEF DESCRIPTION OF THE DRAWINGS

FIG. 1 illustrates an exemplary system diagram of a power generation system, according to one embodiment;

FIG. 2 illustrates an exemplary system diagram of a power generation system, according to one embodiment;

FIG. 3 illustrates an exemplary installed power generation system, according to one embodiment;

FIG. 4A illustrates an exemplary system diagram of a power generation system, according to one embodiment;

FIG. 4B illustrates a detail view of the system diagram of the power generation system of FIG. 4A;

FIG. 4C illustrates another detail view of the system diagram of the power generation system of FIG. 4A;

FIG. 5 illustrates an exemplary circuit diagram of a power generation system, according to one embodiment;

FIG. 6 illustrates an exemplary system diagram of a power generation system, according to one embodiment;

FIG. 7 illustrates a perspective view of an exemplary deployment system for a power generation system, according to one embodiment;

FIG. 8A illustrates a system diagram of an exemplary removal system for a power generation system, according to one embodiment;

FIG. 8B illustrates an additional system diagram of the exemplary removal system of FIG. 8A;

FIG. 8C illustrates a perspective view of a spacer within the power generation system of FIG. 1, according to one embodiment;

FIG. 8D illustrates a perspective view of a spacer within the power generation system of FIG. 1, according to one embodiment;

FIG. 9A illustrates an exemplary debris management system, according to one embodiment; and

FIG. 9B illustrates an exemplary debris management system, according to one embodiment.

Before explaining various embodiments in detail, it is to be understood that the systems and processes discussed herein are not limited in application to the details of the particular arrangement shown, since the systems and processes are capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

According to particular embodiments, this disclosure generally relates to combining one or more modes of renewable energy generation, and installation of renewable energy systems. More specifically, this disclosure discusses various embodiments of power generation systems involving floating solar panels in waterway systems (e.g., rivers, canals, etc.), which may be used in tandem with a distributed hydrokinetic system. Further, this disclosure discusses aspects of installing hydrokinetic turbines and other solar systems within such waterways. Thus, embodiments of the present disclosure include power generation systems suitable for waterway conveyance and other man-made and natural water conveyance systems.

Existing floating solar panels are intended to be used in non-moving bodies of water (e.g., lakes, seas, bays, ponds, reservoirs, etc.). As such, once water flow rates in waterways increase beyond 0.8 to 1.0 m/s, existing floating solar panels can have structural and flotation issues. Indeed, at these higher flow rates, existing floating solar panels can become partially or fully submerged, thus affecting electrical collection capabilities and overall system performance. In contrast to non-moving bodies of water, waterways (e.g., canals, rivers, etc.) can have water flow rates of 2.0 m/s or higher, and installation of floating solar panels therein may require modification of existing waterway structures. Thus, in some embodiments of the power generation system of this disclosure, existing waterway structures may be modified to anchor one or more floating solar panels to keep them in a relatively stable position within flowing water of at least 0.5 m/s to over 4.0 m/s. In other embodiments, additional structures (e.g., weirs, dams, gates, etc.) may be added to existing waterway structures to reduce water flow and velocity. In some embodiments, the floating solar panels may be removably anchored to the aforementioned structures, the banks of the waterway, or other suitable structures without departing from the principles of this disclosure.

As discussed herein, a power generation system combining floating solar panels and hydrokinetic turbines may represent performance improvements to previous power generation systems and/or waterway systems. For example, floating solar panels may provide a stabilizing hydraulic effect to the water flow within a waterway, which may allow for improved and/or more uniform performance of hydrokinetic turbines installed therein. Moreover, floating solar panels may reduce evaporative losses in the waterway by covering the free surface of the water. Further, floating solar panel performance may be improved from waterway water flows as the moving water may be used to cool the solar panels.

While systems and processes described herein are susceptible of embodiments in many different forms, there are shown in the drawings and will be described in detail herein specific embodiments with the understanding that the present disclosure is an exemplification of the principles of the present systems and processes. It is not intended to limit the systems and processes to the specific illustrated embodiments. The features of the systems and processes disclosed herein in the description, drawings, and claims can be significant, both individually and in any desired combinations, for the operation of the systems/processes in various embodiments. Features from one embodiment can be used in other embodiments.

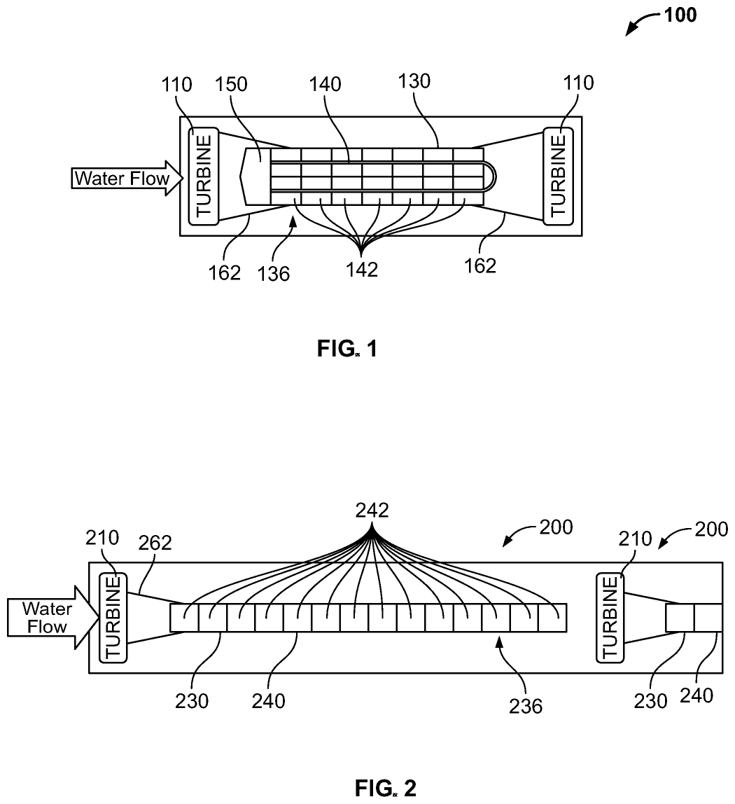

Referring to FIG. 1, a power generation system 100 for installation in a waterway is depicted in a system diagram. The waterway may be a natural waterway (e.g., natural river, canalized river, etc.) or a man-made waterway (e.g., canal), and wherein the waterway may be relatively shallow and/or narrow. As shown, in some embodiments, the power generation system 100 can include one or more turbines 110, a floating frame 130 having a power module 136 disposed thereon, a bow 150, and one or more mooring systems 162. In at least one embodiment, the power module 136 may comprise a solar string 140 having one or more solar panels 142 attached thereto (e.g., in an array).

In some embodiments, solar panels 142 may be electrically connected within the solar string 140 such that individual solar panels 142 may be removed or replaced for any desired reason, such as maintenance or failure of a panel, without removing the solar string 140 from the waterway or disconnecting the other solar panels in the solar string 140. In certain embodiments, it may be possible to “hot swap” individual solar panels 142 within the solar string 140, e.g., replacing a solar panel without stopping, shutting down, or otherwise disrupting the operation of the power generation system 100. In various embodiments, one or more components of the power generation system 100 may be modular and comprise waterproof (e.g., at least IP68) and/or marine grade subcomponents, such as wiring or casing.

Additionally, one or more components of the power generation system 100 may tolerate a wind load of at least 25.0 m/s to 35.0 m/s, at least 30.0 m/s to 40.0 m/s, or at least 35.0 m/s to 45.0 m/s. Further, one or more components of the power generation system 100 may tolerate a snow load of at least 10 psf to 20 psf, at least 15 psf to 25 psf, or at least 20 psf to 30 psf.

In at least one embodiment, the power generation system 100 can include one or more turbines 110 (e.g., hydrokinetic turbines) installed within a waterway. In some embodiments, a first turbine 110 may be positioned upstream from a second turbine 110 with respect to the direction of flowing water. In other embodiments, turbines 110 may be positioned in any suitable position relative to each other without departing from the principles of this disclosure. Additionally, the one or more turbines 110 may be vertical turbines such as those disclosed in U.S. patent application Ser. No. 16/824,470 filed on Mar. 19, 2020, entitled “Flume”, and U.S. patent application Ser. No. 16/089,943 filed on Mar. 28, 2017, entitled “Hydrokinetic Turbine System,” both of which are hereby incorporated by reference in their entirety.

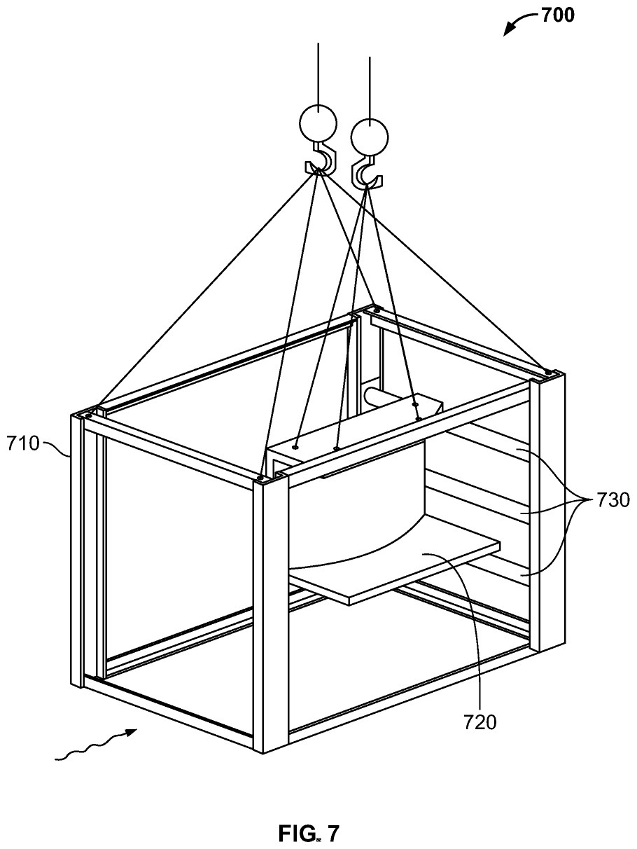

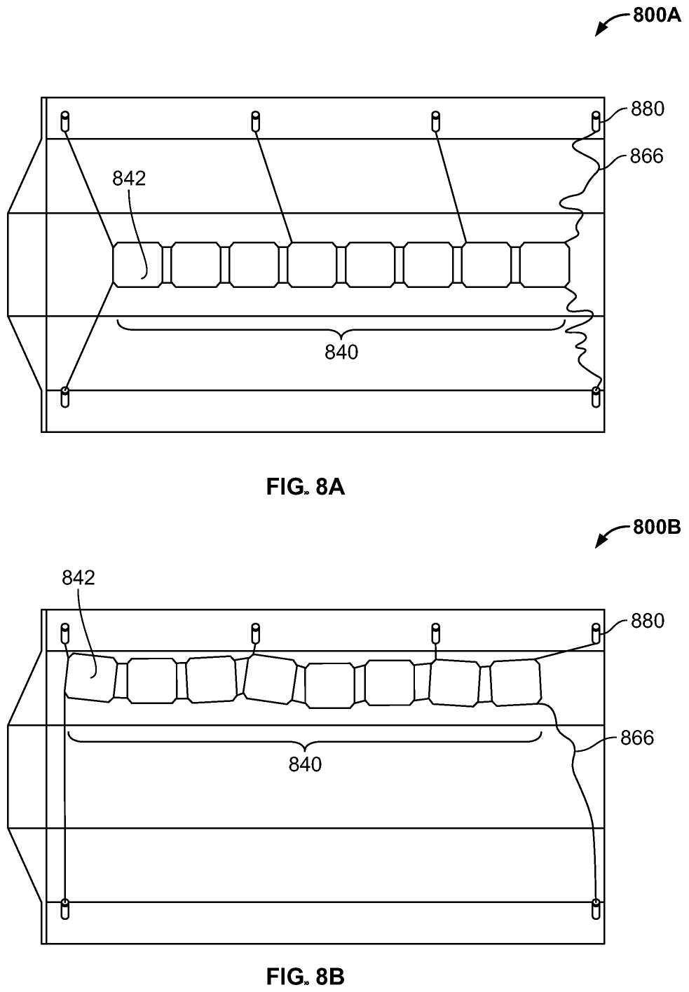

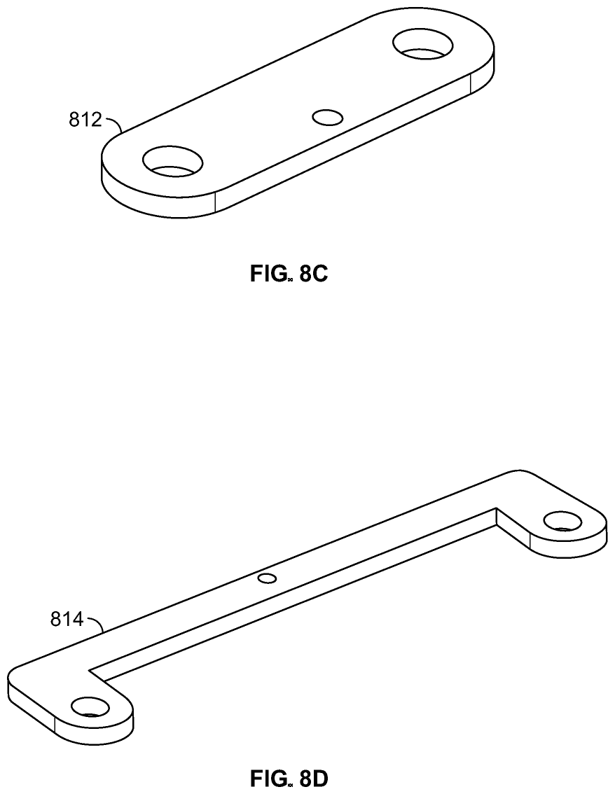

According to some embodiments, the one or more turbines 110 may be distributed in the waterway in series or within an array, and spaced about 25 feet to 75 feet, 50 feet to 100 feed, 75 feet to 125 feet, 100 feet to 200 feet, about 150 feet to 250 feet, about 200 feet to 300 feet, about 250 feet to 350 feet, about 300 feet to 400 feet, about 350 feet to 450 feet, about 400 feet to 500 feet, about 450 feet to 550 feet, about 500 feet to 600 feet, about 550 feet to 650 feet, or about 600 feet to 700 feet apart from any adjacent turbine 110. The particular distribution of the turbines 110 within the waterway can provide unique mooring or anchoring points for the power module 136 components (e.g., solar string 140, floating solar panels 142) with minimal to no permanent modification to existing waterway structures. As will be discussed with reference to FIGS. 7, 8A, and 8B, the present disclosure further involves mechanisms and processes for installing and removing components of the power generation system 100 (e.g., arrays of turbines 110 and/or power modules 136 within a waterway), and systems for collecting power from such arrangements.

According to some embodiments, the floating frame 130 can be provided between each of the one or more turbines 110. In the embodiment shown, the floating frame 130 may be provided between two turbines 110, but in other embodiments, the floating frame 130 can be provided between any suitable number of turbines 110 without departing from the principles of this disclosure. In some embodiments, the one or more turbines 110 may be omitted and the floating frame 130 may be moored or removably attached to any suitable structure without departing from the principles of this disclosure. In some embodiments, the floating frame 130 may be provided in one or more portions such that one portion of the floating frame 130 may include one system component (e.g., one solar panel 142) disposed thereon. The floating frame 130 may be designed to reduce float drag for the power generation system 100, mitigate the impact of rising water levels within the waterway, and/or prevent disruption to other uses of the waterway (e.g., irrigation) as well as to the surrounding aquatic ecosystem. For instance, in some embodiments, the floating frame 130 may relatively buoyant and low profile, while in other embodiments, the floating frame 130 may be perforated, water permeable, modular, or any other suitable configuration without departing from the principles of this disclosure.

In some embodiments, the floating frame 130 may comprise a power module 136 disposed thereon. In some embodiments, the power module 136 can be provided in the form of at least one solar string 140 that, in turn, may include one or more floating solar panels 142 positioned thereon. In other embodiments, the power module 136 can be provided in the form of one floating solar panel 142 system; a solar panel 142 supercapacitor system; a submerged solar panel 142 system; one or more solar panels 142 installed on, integrated with, or otherwise connected to other components of the power generation system 100; a liner or similar surface covering (e.g., coating) integrated with one or more solar panels 142 for covering one or more surfaces of the power generation system 100; or any other suitable configuration without departing from the principles of the disclosure. The floating solar panels 142 may be of any suitable type and/or source, including monocrystalline, polycrystalline, flexible thin-film, organic/plastic, hybrid, solar cell coating, or any other photovoltaic device or system designed to capture and collect solar energy.

According to some embodiments, the solar string 140 may include a length of about 25 feet to 75 feet, about 50 feet to 100 feet, about 75 feet to 125 feet, about 100 feet to 200 feet, about 150 feet to 250 feet, about 200 feet to 300 feet, about 250 feet to 350 feet, about 300 feet to 400 feet, about 350 feet to 450 feet, about 400 feet to 500 feet, about 450 feet to 550 feet, or about 500 feet to 600 feet. Then, depending on a given length of the solar string 140, an array of solar panels 142 may be arranged into any suitable number of rows and any suitable number of columns on the solar string 140 without departing from the principals of this disclosure. For instance, the floating solar panels 142 can be positioned on the solar string 140 in the form of an array of individual solar panels 142 in “r” rows and “c” columns. Such an array may be arranged depending on a variety of factors including, but not limited to, a width of the waterway, dimensions of the solar panels 142, a total number of available solar panels 142, a length of the solar string 140, expected weather conditions (e.g., based on the location, seasonal fluctuations, typical amount of sunlight per day), and expected level of power generation (e.g., about 1 kW to 2 kW, 2 KW to 5 kW, 5 KW to 10 KW, 10 kW to 20 kW, etc.). In some embodiments, the array of solar panels 142 can be modular (in tandem with the floating frame 130) to maximize taking advantage of available resources and surface area within a waterway.

In one non-limiting example, such as the embodiment shown, the array of solar panels 142 may include fourteen solar panels 142 divided into two rows and seven columns. In another non-limiting example, the array of solar panels 142 may include twenty individual solar panels 142 (e.g., 2×5, 4×5, 5×4). In certain embodiments, the solar string 140 may include one solar panel 142. In some embodiments, spacing (“cabling”) between individual solar panels 142 can be minimized to improve performance and efficiency of the power generation system 100. In various embodiments, one or more features disposed on the floating frame 130 (or incorporated as part of the power module 136) may vary the angle of the solar panels 142 such that the solar panels 142 may follow the path of solar rays over the course of the day.

In some instances, flowing water within a waterway can cool or partially cool the solar string 140 and/or the solar panels 142 and provide a stabilizing hydraulic effect, which may allow for better and more uniform performance of the one or more turbines 110. Additionally, the solar string 140 and solar panels 142 may reduce evaporative losses in the waterway by covering the free surface of the flows.

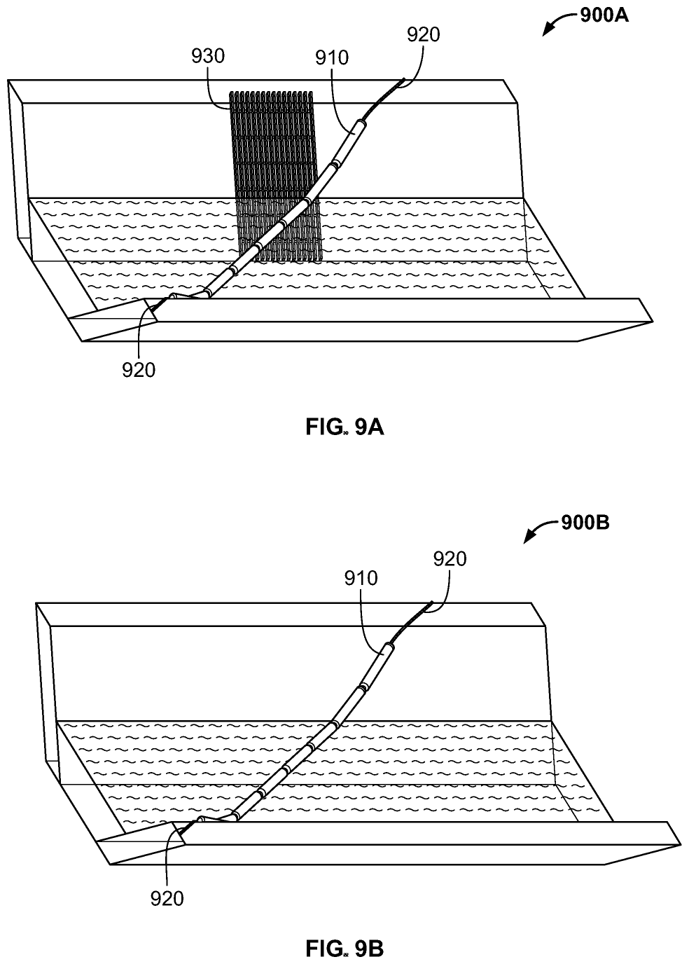

In some embodiments, the floating frame 130 can include a submergence management system, such as a bow 150. In some embodiments, the bow 150 may be positioned upstream from the floating frame 130 to prevent submergence of the power module 136 under high velocity water flows or turbulence, and/or to prevent damage to the power module 136 from debris. Further, the bow 150 may provide additional buoyancy for the floating frame 130. As will be discussed with reference to FIGS. 9A-9B, additional structures may be provided with the power generation system 100, or any other embodiment of the power generation system, to protect the system components from damage caused by debris, turbulent flows, or other undesirable environmental condition.

According to some embodiments, the power generation system 100 can include one or more mooring systems 162 designed to anchor the power generation system 100 within the waterway, such as within the walls or banks of the waterway, to reduce modifications to the waterway. In the embodiment shown, the power generation system 100 may include a first and second mooring system 162. Here, the first of the one or more mooring systems 162 may couple a first portion of the floating frame 130 to the first of the one or more turbines 110, and the second of the one or more mooring systems 162 may couple a second portion of the floating frame 130 to the second of the one or more turbines 110, thereby securing the floating frame 130 between each the one or more turbines 110. In particular, the one or more mooring systems 162 may each include subcomponents such as, but not limited to, ground anchors, chains, ropes, and tension links to provide dynamic stability to the power generation system 100. In some embodiments, the power generation system 100 can include any suitable number of mooring systems 162 to secure the system 100 to portions of the waterway and/or other system components without departing from the principles of this disclosure.

In some embodiments, the one or more mooring systems 162 can be designed to accommodate varying water levels and velocities, as well as drop, depending on the positioning within a waterway. For instance, a first of the one or more mooring systems 162 may moor the first portion of the power generation system 100 at a different height than the second of the one or more mooring systems 162 may moor the second portion of the system 100. Such difference in height may be achieved via a combination of mooring leads that can be provided at top, side, and/or bottom portions of each of turbines 110 (e.g., flumes of the turbines 110).

In some embodiments, use of the one or more mooring systems 162 may be omitted. In such embodiments, the floating frame 130 may be coupled directly to the one or more turbines 110 (e.g., without using the mooring system 162 subcomponents, such as a tension link, etc.) such that the floating frame 130 can leverage a load bearing capacity of the one or more turbines 110. In these embodiments, it may not be necessary to include additional mooring and/or anchoring equipment, thus reducing overall system complexity.

Referring to FIG. 2, an alternative configuration of a power generation system 200 is shown in a system diagram. In some embodiments, the power generation system 200 may include some or all of the features and functionalities as the power generation system 100 discussed with reference to FIG. 1, such as a floating frame 230 having a power module 236 positioned thereon and connected downstream from a turbine 210 via a mooring system 262. In some embodiments, similar to the embodiment discussed with reference to FIG. 1, the power module 236 can include a solar string 240, wherein the solar string 240 may include one or more solar panels 242 arranged in an array. For the sake of brevity, similar features will not be described again in detail.

In some embodiments, the power generation system 200 may particularly include a power module 236 with one or more floating solar panels 242 arranged in series (or in a single row array) on a solar string 240, thus allowing deployment of the system 200 in relatively narrow waterways. In such cases, there may not be a need for more than one mooring system 262 to moor the power generation system 200 to the waterway or to the turbines 210. Furthermore, more than one power generation system 200 may be deployed within the same waterway, wherein one system 200 may be provided upstream from an adjacent system 200. As such, various combinations of the system 100, system 200, and any other suitable system configurations are contemplated herein to provide custom lengths and widths for unique sizes and geometry of various waterways.

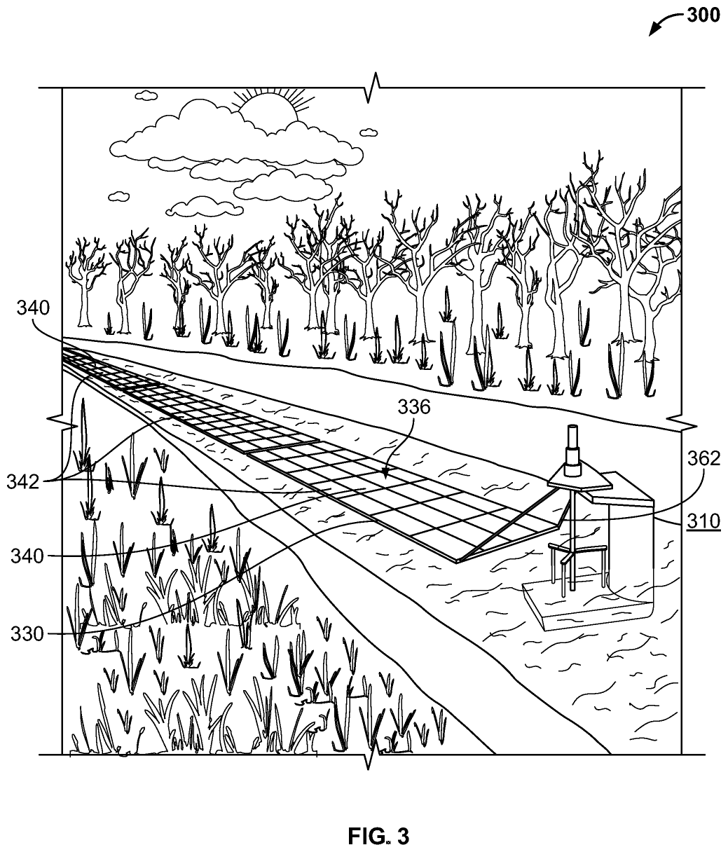

For instance, FIG. 3 illustrates one configuration of a power generation system 300 installed within a waterway. In some embodiments, the power generation system 300 may include some or all of the features and functionalities as the power generation systems 100, 200 discussed with reference to FIGS. 1 and 2, respectively, such as a floating frame 330 having a power module 336 positioned thereon and connected downstream from a turbine 310 via a mooring system 362. In some embodiments, similar to the discussion with reference to FIGS. 1 and 2, the power module 336 can include a solar string 340, wherein the solar string 340 may include one or more solar panels 342 arranged in an array. For the sake of brevity, similar features will not be described again in detail.

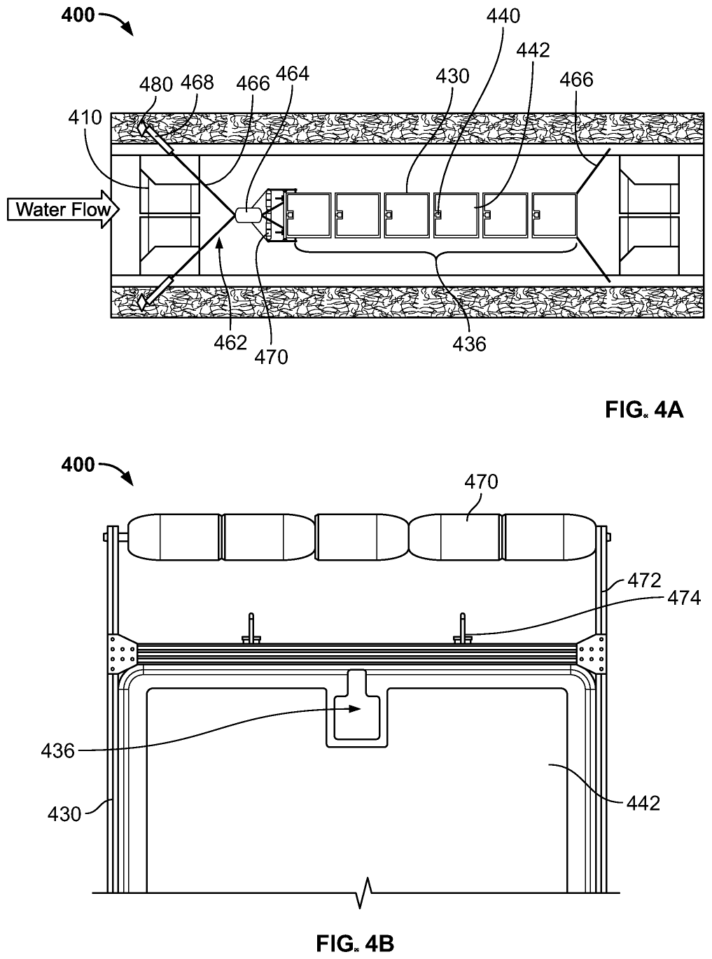

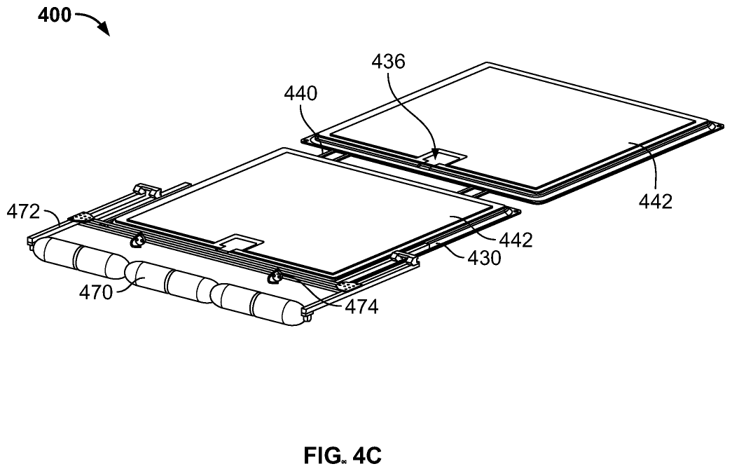

FIG. 4A-C illustrate an alternate configuration of a power generation system 400, shown in a system diagram. In some embodiments, the power generation system 400 may include some or many of the features and functionalities as the power generation systems 100, 200 discussed with reference to FIGS. 1 and 2, such as a floating frame 430 having a power module 436 positioned thereon and connected downstream from a turbine 410 via a mooring system 462. In some embodiments, similar to the embodiment discussed with reference to FIG. 1, the power module 436 can include a solar string 440, wherein the solar string 440 may include one or more solar panels 442 arranged in an array. For the sake of brevity, similar features will not be described again in detail.

According to some embodiments, the power generation system 400 can include one or more mooring systems 462, similar to the mooring system 162 of FIG. 1. Here, one mooring system 462 may couple a first portion of the floating frame 430 to the first of one or more turbines 410. In particular, the mooring system 462 may include subcomponents such as, but not limited to, a tension link 464, one or more ropes 466, one or more chains 468, and one or more ground anchors 480 to provide dynamic stability to the power generation system 400. With particular reference to FIGS. 4B and 4C, one or more hooks 474 may be disposed on a portion of the floating frame 430, wherein the hooks 474 may provide a point of attachment for the mooring system 462 with the floating frame 470. In some embodiments, a second portion of the floating frame 430 may be coupled directly to the second of one or more turbines 410 via one or more ropes 466, or any other suitable alternative. Thus, the floating frame 430 may be secured between each the one or more turbines 410. In some embodiments, the power generation system 400 can include any suitable number of mooring systems 462 to secure the system 400 to portions of the waterway and/or other system components without departing from the principles of this disclosure. In certain embodiments, the power generation system 400 may be moored directly to the banks of the waterway, without being moored to a turbine 410 without departing from the principles of this disclosure.

According to some embodiments, the power generation system 400 can include a floating frame 430 provided with a submergence management system, such as a buoy 470, to provide additional buoyancy to the floating frame 430. In some embodiments, the buoy 470 may be used instead of or in addition to an optional bow (such as the bow 150 described with reference to FIG. 1). In some embodiments, the buoy 470 may be positioned upstream from the floating frame 430 to prevent submergence of the power module 436 under high velocity water flows or turbulence, and/or to protect the power module 436 from debris. In some embodiments, additional buoys 470 may be positioned in any suitable configuration without departing from the principles of this disclosure. In some embodiments, the buoy 470 may be coupled to a portion of the mooring system 462 (e.g., the tension link 464) in addition to the floating frame 430, while in other embodiments, the buoy 470 may be coupled to only the floating frame 430. As will be discussed with reference to FIGS. 9A-9C, additional structures may be provided with the power generation system 400, or any other embodiment of the power generation system, to protect the system components from debris and/or turbulent flows.

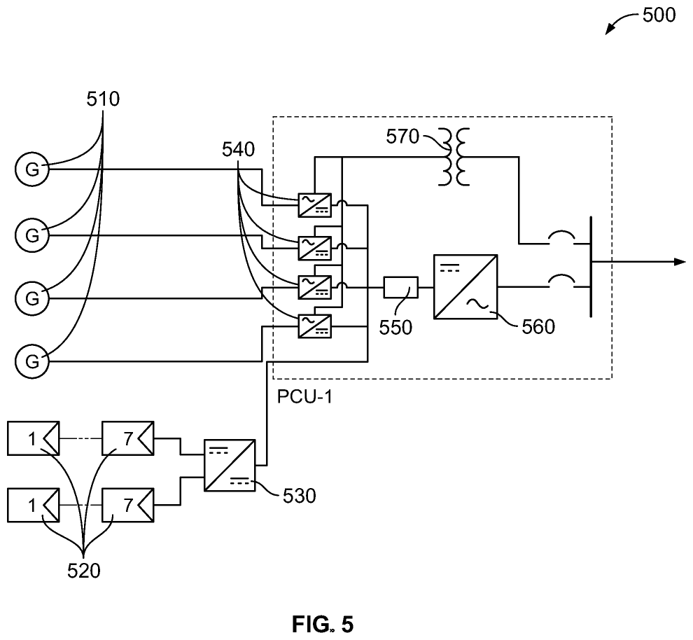

FIG. 5 illustrates a circuit diagram for an exemplary embodiment of a power generation system 500. In this embodiment, the power generation system 500 may include any suitable number of turbines 510 and solar panels 520, wherein the solar panels 520 may be connected to a DC string optimizer 530. In some embodiments, the turbines 510 may produce alternating current (AC) power while the solar panels 520 produce direct current (DC) power. In some embodiments, depending on system preferences and array arrangement of the solar panels 520, the solar panels 520 may be connected to the DC string optimizer 530 via a single connection (e.g., one connection for all of the solar panels 520) or via individual connections (e.g., one connection per solar panel 520).

Additionally, the one or more turbines 510 may each be connected to at least one rectifier 540, wherein the at least one rectifier 540 may be active or passive. In some embodiments, the at least one rectifier 540 may convert power generated by the turbines 510 from AC power into DC power. Furthermore, the DC string optimizer 530 and the rectifiers 540 may be connected to a bus 550 that itself may be connected to an inverter 560. Moreover, the rectifiers 540 may further be connected to an isolation transformer 570. Therefrom, the power generated by the turbines 510 and the solar panels 520 may be integrated on the same AC grid, which may reduce a cost and/or complexity of an overall power system.

In some embodiments, one or more turbine 510 may be provided within the system 500, wherein each turbine 510 may provide up about 1 kW to 2 kW, about 2 kW to 5 KW, about 5 kW to 10 KW, about 7.5 kW, or about 10 KW to 20 KW of AC power. For instance, the one or more turbines 510 may be the one or more turbines 110 of FIG. 1, or the one or more turbines 210 of FIG. 2, or the one or more turbines 410 of FIG. 4A. In one non-limiting example, about twenty turbines 510 of 5 kW size may be spaced approximately 330 feet apart within an array or in series, totaling approximately 100 kW.

In some embodiments, one or more solar panels 520 may be provided within the system 500, wherein each solar panel 520 may provide about 100 to 200 W, about 150 to 250 W, about 200 to 300 W, about 250 to 350 W, about 300 to 400 W, about 350 to 450 W, about 400 to 500 W, about 450 to 550 W, about 540 W, about 500 to 600 W, or about 550 to 650 W of DC power. For instance, the one or more solar panel 520 may correspond to the solar panels 142 of FIG. 1, or the solar panels 242 of FIG. 2, or the solar panels 442 of FIG. 4A. In one non-limiting example, about twenty floating solar panels 520 disposed on twenty DC strings 530 may be sized about 0.5 kW and positioned over 130 feet of floating frame between the turbines 510, totaling about 200 kW.

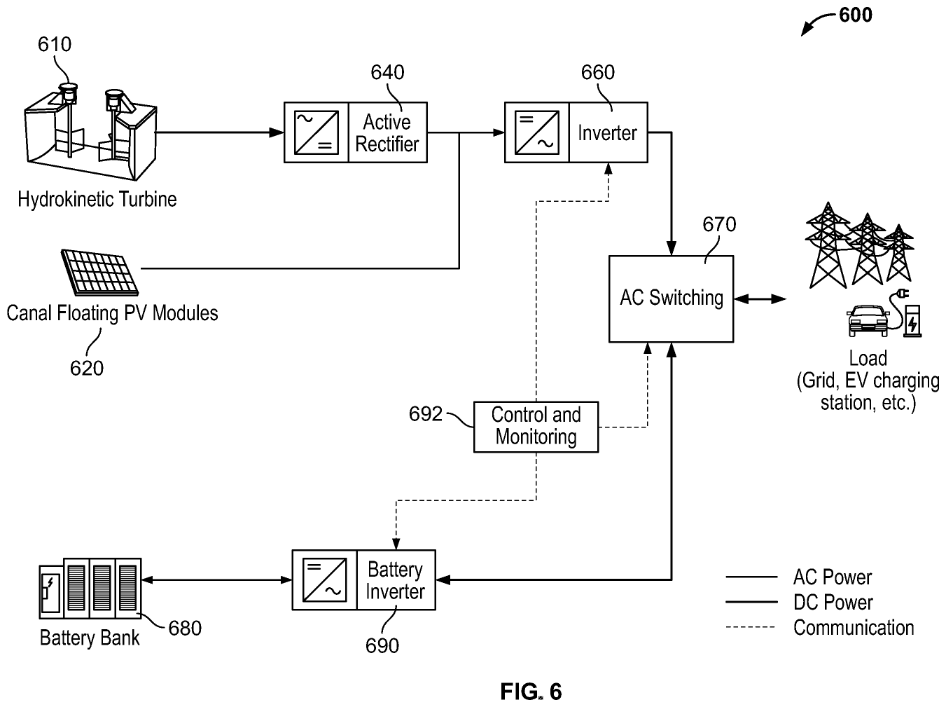

Referring to FIG. 6, an alternative circuit diagram for an exemplary embodiment of a power generation system 600 is shown. In some embodiments, similar to the embodiment discussed with reference to FIG. 5, the system 600 may include one or more turbines 610 each connected to a rectifier 640 to convert AC power generated from the turbines 610 into DC power. In some embodiments, the system 600 may further include one or more solar electricity modules 620 that generates DC power, which may be connected to a string optimizer (not shown). The rectifier 640 and the solar electricity modules 620 may further be connected to an inverter 660 to convert the DC power into AC power. For the sake of brevity, similar features will not be described again in detail.

In some embodiments, the inverter 660 may further be connected to a switch 670 which itself may be connected to one or more loads (e.g., a grid, an EV charging station, etc.). Moreover, a battery bank 680 containing one or more batteries may also be provided with the power generation system 600. In some embodiments, the battery bank 680 may be connected to a converter 690 such that the converter 690 can convert AC power from the switch 670 into DC power and/or convert DC power from the battery bank 680 into AC power. Furthermore, a control system 692 may be provided for the system 600 to monitor and/or control various system components. For instance, the control system 692 may be connected to the inverter 660, the converter 690, and/or the switch 690.

Referring now to FIG. 7, one embodiment of a deployment system 700 for deploying one or more components of a power generation system (as described herein) is shown. In some embodiments, the deployment system 700 may be used to quickly and efficiently deploy/retrieve components of the power generation system from a side of a waterway with minimal disruption to waterway operations and structure, and minimal damage to the power generation system (e.g., “submarining” of solar panels). For instance, in some embodiments, some or all portions of the deployment system 700 may comprise semi-permanent mooring installation already present within existing waterway structures (e.g., flumes). Additionally, the deployment system 700 may be designed to install/remove individual components of the power generation system. As such, in some embodiments, no permanent modification or structural installation may be required within the waterway, and repairs to the power generation system may be made within the waterway without requiring complete removal.

According to some embodiments, the deployment system 700 may include a frame 710 designed to support a flume 720, or any other suitable system component, during installation within and removal from a waterway. The frame 710 may provide temporary support in the waterway and may ensure minimal movement and sideload while a lifting device, such as a crane, is lowering and/or lifting portions of the flume 720, thereby allowing for rapid deployment and installation of the power generation system without impeding water flow within the for example, damming or shutting off water to the canal or a portion of the canal during flume or floating PV installation or removal. For instance, one or more features of the deployment system 700 may enable removal/installation of solar panels at an optimal static angle, thereby reducing damage to the waterway and/or power generation system. In other embodiments, one or more features of the deployment system 700 may angle system components, such as the solar panels disposed on the floating frame, to improve installation in waterways with sloped surfaces. In some embodiments, frame 710 may further include one or more rollers 730 to guide the flume 720 as it is lowered during installation.

In some embodiments, the frame 710 may further include one or more rollers 730 to slide and/or to support installation of the flume 720, which may be installed in components (e.g., bottom, sidewalls, etc.). As will be understood from discussions here, the frame 710 may include any suitable support or supports for installing the flume 720 (or other components of the power generation system), including a rail, bars or spreader bars, hoist rings, brackets (e.g., T-brackets, corner brackets), etc. Additionally, the flume 720 may include one or more mooring connections designed for quick release and removal of a floating frame within a water way. In some embodiments, the quick release may allow for easy and rapid deployment and retrieval of the floating frame with minimal to no disruption to waterway operations. In some embodiments, the frame 710 may be adapted to perform vertical lift and/or horizontal slide of system components into and out of a waterway. In some embodiments, a pulley system may be provided with the deployment system 700 to evenly disperse mechanical forces and improve installation of the power generation system. In other embodiments, a buoy system (see FIG. 4A) or bow system (see FIG. 1) provided with the power generation system may further prevent submarining of system components when using the deployment system 700.

Referring to FIGS. 8A and 8B, one embodiment of an installation/removal system 800A for a power generation system is shown. In some embodiments, the power generation system components (e.g., floating frame, array of solar panels 842 disposed on a solar string 840) is assembled prior to installation and may remain assembled such that the assembled components slide down and up the walls of a waterway during the installation and removal process. In some embodiments, plastic/rubber mats or wooden framing may first be positioned on the walls of the waterway to protect components of the power generation system from damage. One or more removal posts 880 may be positioned at the walls of the waterway and adjacent to the power generation system, spaced every 10 to 20 feet, every 15 to 25 feet, every 20 to 30 feet, every 25 to 35 feet, every 30 to 40 feet, or every 35 to 40 feet. Then, one or more mooring cables 866 (e.g., cable winches) may be fastened to each post 880 at one end of a mooring cable 866, and to a portion of the power generation system at another end of the mooring cable 866. In some embodiments, one or more spreader bars 812, 814 (see FIGS. 8C and 8D) may be positioned along the sides of the power generation system for anchoring the mooring cables 866 with components of the power generation system (e.g., floating frame). The spreader bars may tolerate a load of about 5.0 to 8.0 kN, about 7.0 to 10.0 kN, about 9.0 to 12.0 kN, about 11.0 to 14.0 kN, about 13.0 to 16.0 kN, or about 15.0 to 17.0 kN. Thus, the power generation system may gradually be lowered into the waterway by gradually unwinding the mooring cables 866 until the system is positioned as desired within the waterway. Similarly, the power generation system may be removed from the waterway by gradually winding the mooring cables 866 until the system is suitably removed.

In instances wherein the waterway may be dry, the mooring cables 866 may be disconnected or tightened to allow the power generation system to be lowered into the waterway or pulled up the side of the waterway (see FIG. 8B). In instances wherein there is water flow within the waterway, the installation/removal system 800A may include primary mooring cables and secondary mooring cables. Thus, primary cables may be the standard mooring cables for keeping an installed power generation system stationary and may be detached for seasonal removal of the system. Meanwhile, secondary mooring cables may be longer to allow for slack within the cable, thus facilitating safe and stable installation/removal of the power generation system. Thus, one or more embodiments of the installation/removal system 800A provide for quick installation/retrieval of the power generation system.

Turning now to FIG. 9A, one embodiment of a debris management system 900A for use with a power generation system (as described herein) is shown. In some embodiments, the debris management system 900A includes a boom 910 (see FIG. 9B) and a debris removal ramp 930 (see FIG. 9C) installed within a waterway. As shown, the debris removal ramp 930 may be installed against a sloped portion of the waterway and the boom 910 may be positioned diagonally across the waterway and over a portion of the debris removal ramp 930. Thus, the boom 910 may guide debris to the banks of the waterway and the debris removal ramp 930 may provide a surface to ease debris removal and protect the waterway lining. In some embodiments, the debris removal ramp 930 may include rails to enhance manual removal of debris. In some embodiments, the boom 910 may comprise a temporary floating barrier or any other suitable barrier without departing from the principles of this disclosure. In some embodiments, the debris removal ramp 930 may comprise a rake, a debris rack, or any other suitable device without departing from the principles of this disclosure.

Specific embodiments of a renewable energy generation and collection system have been described for the purpose of illustrating the manner in which the present systems and processes can be made and used. It should be understood that the implementation of other variations and modifications of systems and processes and their different aspects will be apparent to one skilled in the art, and that systems and processes are not limited by the specific embodiments described. Features described in one embodiment can be implemented in other embodiments. The subject disclosure is understood to encompass the present systems and processes and any and all modifications, variations, or equivalents that fall within the spirit and scope of the basic underlying principles disclosed and claimed herein.

It will be understood that the present disclosure generally discusses electricity generation systems combining hydrokinetic turbine systems with floating solar panel systems. However, this disclosure is not limited to such system components. For example, other embodiments are contemplated herein may include hydrokinetic turbine systems used in combination with canal-spanning solar systems (collection of electricity from such systems), along with other types of energy generation sources.

What is claimed is:

1. A power generation system comprising:
a first turbine positioned in a waterway; and
a floating frame positioned downstream from the first turbine; and
at least one solar panel attached to the floating frame.

2. The power generation system of claim 1 further comprising:
a first mooring coupling the floating frame to the first turbine.

3. The power generation system of claim 2 further comprising:
a second turbine positioned downstream from the floating frame; and
a second mooring coupling the floating frame to the second turbine.

4. The power generation system of claim 1 further comprising:
a first mooring coupling the floating frame to a first portion of the waterway.

5. The power generation system of claim 4 further comprising:
a second turbine positioned downstream from the floating frame; and
a second mooring coupling the floating frame to a second portion of the waterway.

6. The power generation system of claim 1, wherein the at least one solar panel comprises a string of solar panels.

7. The power generation system of claim 6, wherein the string of solar panels further comprises a plurality of rows of solar panels.

8. The power generation system of claim 1, wherein the at least one solar panel is a photovoltaic panel.

9. The power generation system of claim 1 further comprising a switch, wherein the switch is configured to output both a power generated by the first turbine and a power generated by the at least one solar panel.

10. The power generation system of claim 1 further comprising:
a rectifier connected to the first turbine; and
an inverter connected to the rectifier, wherein the inverter is further connected to the at least one solar panel.

11. The power generation system of claim 10, wherein the at least one solar panel is connected to the inverter through a DC string optimizer.

12. The power generation system of claim 10 further comprising:
a battery bank connected to a converter; and
a switch connected to both the inverter and the converter, wherein the switch is configured to output both a power generated by the first turbine and a power generated by the at least one solar panel.

13. The power generation system of claim 12 further comprising:
a control system connected to the inverter, the switch, and the converter.

14. The power generation system of claim 1 further comprising:
a bow positioned upstream of the floating frame.

15. The power generation system of claim 1 further comprising at least one buoy positioned upstream of the floating frame.

16. A method of generating electric power comprising:
generating, via a first power source, a first AC power;
generating, via a second power source, a first DC power;
rectifying, via a rectifier, the first AC power into a second DC power;
combining, via a bus, the first DC power and the second DC power into a third DC power;
inverting, via an inverter, the third DC power into a second AC power; and
outputting the second AC power.

17. The method of generating power of claim 16, wherein the first power source is a hydrokinetic turbine generator.

18. The method of generating power of claim 16, wherein the second power source is one or more photovoltaic panels.

19. The method of generating power of claim 16 further comprising:
converting, via a converter, the second AC power into a fourth DC power; and
storing, via a battery bank, the fourth DC power.

20. The method of generating power of claim 16 further comprising:
providing the first power source and the second power source in a body of moving water.

21. A method for installing a power generating system comprising:
inserting a support frame into a body of moving water;
inserting one or more portions of a hydrokinetic turbine into the body of moving water within the support frame;
removing the support frame from the body of moving water; and
removably anchoring a floating frame comprising at least one photovoltaic panel within the body of moving water.

22. The method of claim 21, wherein the step of removably anchoring a floating frame within the body of moving water further comprises:
providing a mooring system; and
connecting one or more portions of the floating frame with one or more portions of the hydrokinetic turbine.

23. The method of claim 21, wherein the step of removably anchoring a floating frame within the body of moving water further comprises:
providing a mooring system; and
connecting one or more portions of the floating frame with one or more areas adjacent to the body of moving water.

24. A power generation system for use within a waterway, the power generation system comprising:
a floating frame positioned within the waterway;
a power module positioned on a top surface of the floating frame;
a submergence management system positioned upstream of the floating frame; and
a mooring system configured to removably anchor the floating frame within the waterway.

25. The power generation system of claim 24, further comprising a hydrokinetic turbine positioned upstream of the floating frame.

26. The power generation system of claim 24, wherein the power module includes at least one solar panel.

27. The power generation system of claim 26, wherein the at least one solar panel comprises a string of solar panels.

28. The power generation system of claim 24, wherein the submergence management system includes a bow.

29. The power generation system of claim 24, wherein the submergence management system includes a buoy.

30. The power generation system of claim 24, further comprising a debris management system positioned upstream of the floating frame, wherein the debris management system includes a floating barrier and a debris removal ramp.
